(19) United States
(12) Patent Application Publication
(10) Pub. No.: US 2009/0297667 A1
(43) Pub. Date: Dec. 3, 2009

(54) Packaging of Meat Products with Modified Atmospheres

(75) Inventors: David C. Ruzek, Austin, MN (US); Chad H. Donicht, Austin, MN (US)

Correspondence Address: IPLM GROUP, P.A., POST OFFICE BOX 18455, MINNEAPOLIS, MN, 55418, US

(73) Assignee: Hormel Foods Corporation

(21) Appl. No.: 12/260,232

(22) Filed: Oct. 29, 2008

Related U.S. Application Data
(60) Provisional application No. 60/983,417, filed on Oct. 29, 2007.

(51) Int. Cl. B65D 81/20; B65D 81/24; A23B 4/16

(52) U.S. Cl. 426/87; 426/129; 426/127; 426/118; 426/316

(57) ABSTRACT

A product packaging comprises a base, a lid, a meat product, and a gas within a space between the base, the lid, and the meat product. The base and the lid form a cavity having a first volume. The meat product has a first color and a second volume. The second volume is smaller than the first volume. The cavity is configured and arranged to receive the meat product. The space has a third volume that is the difference between the first volume and the second volume. The gas within the space comprises no greater than 30% carbon monoxide, and at least one of the base and the lid has an oxygen transmission rate of 0.1 to 15 cc of oxygen per package in 24 hours so that in 18 to 90 days the first color of the meat product has noticeably changed to a second color.

This application claims the benefit of U.S. Provisional Application Ser. No. 60/983,417, filed Oct. 29, 2007.

### FIELD OF THE INVENTION

The present invention relates to packaging of meat products with modified atmospheres.

### BACKGROUND OF THE INVENTION

Traditionally, fresh meat has been marketed in oxygen permeable over-wrap packaging prepared at the retail level. Case-ready packaging systems, which consist of standardized packaging prepared at a central location, have been increasingly used in place of these traditional over-wrap packages. Among the benefits of case-ready packaging are improvements in product quality, presentation, and convenience to both retailers and consumers. Significantly, case-ready meat programs allow for less handling of products prior to retail purchase, enhancing not just convenience and efficiency, but product safety and quality as well.

Modified atmosphere packaging (hereinafter “MAP”) technology is widely employed throughout the food industry and is presently used in many case-ready systems. A modified atmosphere may be achieved in two ways: by removing air from the package (i.e., vacuum packaging) or by replacing, after removal of ambient air, the normal package atmosphere with a specially formulated mixture of gases. Depending upon the desired function of the MAP system, the gaseous mixture may contain differing levels of oxygen, carbon monoxide, carbon dioxide, and/or nitrogen.

Like oxygen, carbon monoxide has been known to have a color-stabilizing effect on fresh meat. The use of relatively low levels of carbon monoxide when used in contact with fresh meat is generally recognized as safe. The desirable red color of fresh beef, in particular, is attributed to oxymyoglobin, which is formed when myoglobin in meat muscle fibers is exposed to oxygen. When carbon monoxide comes into direct contact with meat, myoglobin is converted to carboxymyoglobin, resulting in a color that is substantially indistinguishable from that of oxymyoglobin. In the absence of a modified atmosphere, oxymyoglobin is eventually converted to metmyoglobin, which has an unappealing, brown color and this conversion typically occurs before microbial spoilage renders the product unfit for human consumption. Relatively low levels of carbon monoxide are not known to affect the ability of a MAP system to slow the growth of microorganisms, nor are relatively low levels of carbon monoxide known to affect the characteristic odor of meat spoilage. Moreover, the use of carbon monoxide in the MAP system will not preclude the browning of meat following removal from the modified atmosphere by consumers. In other words, the MAP system including carbon monoxide does not mask spoilage.

The present invention addresses the problems associated with the prior art packaging and provides for a MAP system including carbon monoxide for packaging fresh meat to allow a controlled conversion from carboxymyoglobin to varying degrees of metmyoglobin.

### SUMMARY OF THE INVENTION

One aspect of the present invention provides a product packaging comprising a base, a lid, a meat product, and a gas within a space between the base, the lid, and the meat product. The base and the lid form a cavity having a first volume. The meat product has a first color and a second volume. The second volume is smaller than the first volume. The cavity is configured and arranged to receive the meat product. The space between the base, the lid, and the meat product has a third volume. The third volume is the difference between the first volume and the second volume. The gas within the space comprises no greater than 30% carbon monoxide, and at least one of the base and the lid has an oxygen transmission rate of 0.1 to 15 cc of oxygen per package in 24 hours so that in 18 to 90 days the first color of the meat product has noticeably changed to a second color.

Another aspect of the present invention provides a modified atmosphere packaging configured and arranged to contain a meat product. A base and a lid form a cavity, and there is a space between the base and the lid in which there is a gas. The gas comprises no greater than 1.20% carbon monoxide, 20 to less than 100% carbon monoxide, and 0 to 80% nitrogen. At least one of the base and the lid has an oxygen transmission rate of 0.1 to 15 cc of oxygen per package in 24 hours. The carbon monoxide within the space remains relatively constant and the carbon dioxide within the space decreases at a slow rate.

Another aspect of the present invention provides a method of packaging a meat product to create a product package. The meat product has a first color and is placed in a base. The meat product and the base are placed in packaging equipment. Air is evacuated from the base, and the base is filled with a gas. The lid is sealed to the base. At least one of the base and the lid has an oxygen transmission rate of 0.1 to 15 cc of oxygen per package in 24 hours so that in 18 to 90 days the first color of the meat product has noticeably changed to a second color.

### BRIEF DESCRIPTION OF THE DRAWINGS

FIG. 1 is a side cross-section view of a packaged meat product including a modified atmosphere;

FIG. 2 is a schematic cross-section view of a barrier lid with a micro perforation extending partially through the barrier lid;

FIG. 3 is a photo of a barrier lid with a micro perforation under microscope;

FIG. 4 is a graph showing the percent of carbon monoxide in packaging without a meat product over several days;

FIG. 5 is a graph showing the percent of carbon dioxide in the packaging without a meat product of FIG. 4 over several days;

FIG. 6 is a graph showing the percent of oxygen in the packaging without a meat product of FIG. 4 over several days;

FIG. 7 is a graph showing the percent of carbon monoxide in another packaging without a meat product over several days;

FIG. 8 is a graph showing the percent of carbon dioxide in the packaging without a meat product of FIG. 7 over several days;

FIG. 9 is a graph showing the percent of oxygen in the packaging without a meat product of FIG. 7 over several days;

FIG. 10 is a graph showing the percent of carbon monoxide in another packaging without a meat product over several days;

FIG. 11 is a graph showing the percent of carbon dioxide in the packaging without a meat product of FIG. 10 over several days; and

FIG. 12 is a graph showing the percent of oxygen in the packaging without a meat product of FIG. 10 over several days.

### DETAILED DESCRIPTION OF A PREFERRED EMBODIMENT

A preferred embodiment product packaging constructed according to the principles of the present invention is designated by the numeral 100 in the drawings.

The product packaging includes a MAP system and a meat product. It is recognized that there are numerous MAP systems that could be used with the present invention. An example of a suitable product packaging is a packaged meat product including an enclosure having an interior volume, a meat product within the enclosure and having a first volume that is less than the interior volume, and a gas within the enclosure having a second volume that is preferably no greater than a difference between the interior volume and the first volume. The gas is a substantially non-oxidizing gas. The gas preferably includes no greater than 30% carbon monoxide, and more preferably, no greater than 10% carbon monoxide. Even more preferably, the gas includes 1.20% or less carbon monoxide, 20 to less than 100% carbon dioxide, and 0 to 80% nitrogen.

The carbon monoxide has a color-stabilizing effect on the meat product within the product packaging. The product packaging of the present invention provides a controlled conversion from carboxymyoglobin to varying degrees of metmyoglobin proximate after the stated shelf-life indicia on the product packaging of the meat product. Thus, in addition to the “use by” or “sell by” indicia on the product packaging, the bulging of the product packaging due to gas production generally from microbial spoilage, and the characteristic odor of meat spoilage, the consumer is able to utilize visual inspection of the color of the meat product within the product packaging of the present invention.

Although the meat products discussed herein are beef products, it is recognized that other types of meat products such as, but not limited to, pork and poultry could be used with the present invention. It is recognized that the product packaging may need to be varied or modified depending upon the type of meat products used.

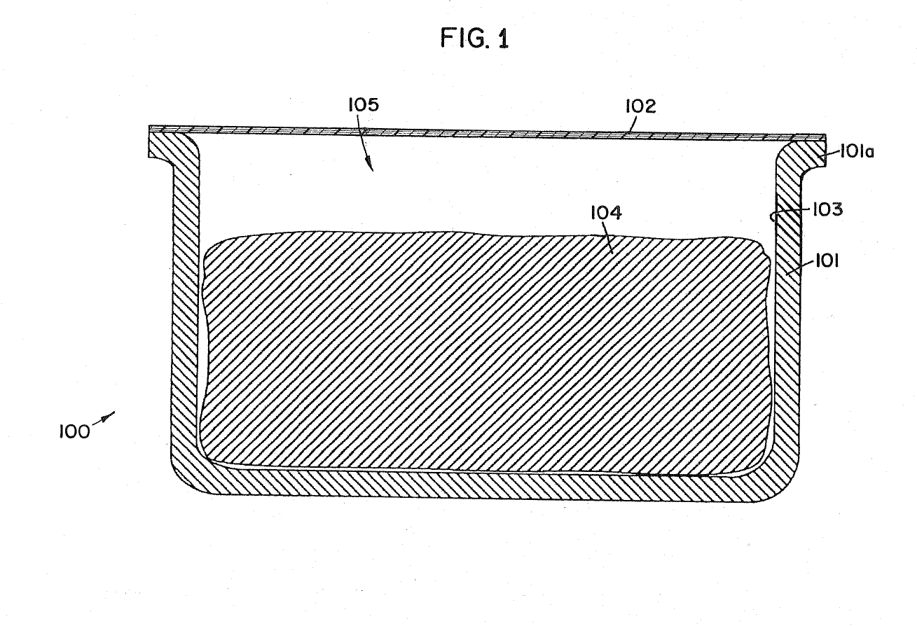

FIG. 1 schematically illustrates an embodiment of a packaged meat product with a suitable MAP system for use with the present invention. The product packaging 100 includes a base 101 to which a lid 102 is connected to form a cavity 103, and a meat product 104 is placed within the cavity 103. The base 101 is preferably a pan or tray like container with a flange 101a extending outward from the top. A seal, preferably a heat seal, is used to connect the lid 102 to the flange 101a. The base 101 is preferably formed of a food-grade plastic such as molded polyester, polystyrene, high density polyethylene (“HDPE”), polyvinylchloride (“PVC”), or polypropylene and is rigid enough to support the meat product 104. Preferably, the base 101 is approximately 10 to 100 mil thick. The lid 102 is preferably a food-grade plastic film such as polyethylene, ethylene vinyl-alcohol (“EVOH”), nylon, polyester, ethylene vinyl acetate (“EVA”), or polypropylene (“PP”). Preferably, the lid 102 is 6 mil or less thick. The lid 102 is preferably at least partially translucent to allow the consumers to visually inspect the meat product 104 through the lid 102. The cavity 103 is larger than the meat product 104 to allow sufficient space 105 for a modified atmosphere. The volume of the space 105 is preferably less than the volume of the meat product 104. The gas to meat volume ratio is preferably no greater than 0.8 to 1. The gas to meat volume ratio is preferably high enough so that the lid 102 does not contact the meat product 104 but is preferably low enough to reduce the amount of space required for shipping, storage, and display of the product packaging 100.

The present invention is not limited to a base 101 and a lid 102 as shown in FIG. 1. It is recognized that other suitable packaging components could be used. Several variations of the product packaging 100 could be used to achieve the desired controlled conversion from carboxymyoglobin to varying degrees of metmyoglobin after the stated shelf-life indicia on the product packaging 100 of the meat product. The base 101, the lid 102, or the base 101 and the lid 102 could be at least semi-permeable to atmospheric air to allow a desired amount of oxygen into the product packaging 100 with minimal diffusion of the MAP gases out of the product packaging 100. Thus, semi-permeable in this application preferably means that the packaging is somewhat more permeable to oxygen than barrier materials such as ethylene vinyl alcohol (“EVOH”).

One possible product package could include a non-barrier base and a barrier lid. Non-barrier means at least semi-permeable to gas, and barrier means substantially non-permeable to gas. The base could be a monolayer polypropylene tray without an ethylene vinyl alcohol (“EVOH”) layer such as a permeable polypropylene tray available from Rexam Plc of London, United Kingdom and Cryovac Food Packaging of Duncan, S.C. The lid could be an oxygen barrier film with an EVOH layer such as LID1050 lidstock available from Cryovac Food Packaging of Duncan, S.C. The EVOH layer is the barrier layer.

Another possible product package could include a barrier base and a non-barrier lid. The base could be a polypropylene tray with an EVOH layer. The lid could be a semi-permeable film without an EVOH layer.

Another possible product package could include a non-barrier base and a non-barrier lid. The base could be a monolayer polypropylene tray without an EVOH layer such as a permeable polypropylene tray available from Rexam Plc of London, United Kingdom and Cryovac Food Packaging of Duncan, S.C. The lid could be a semi-permeable film without an EVOH layer.

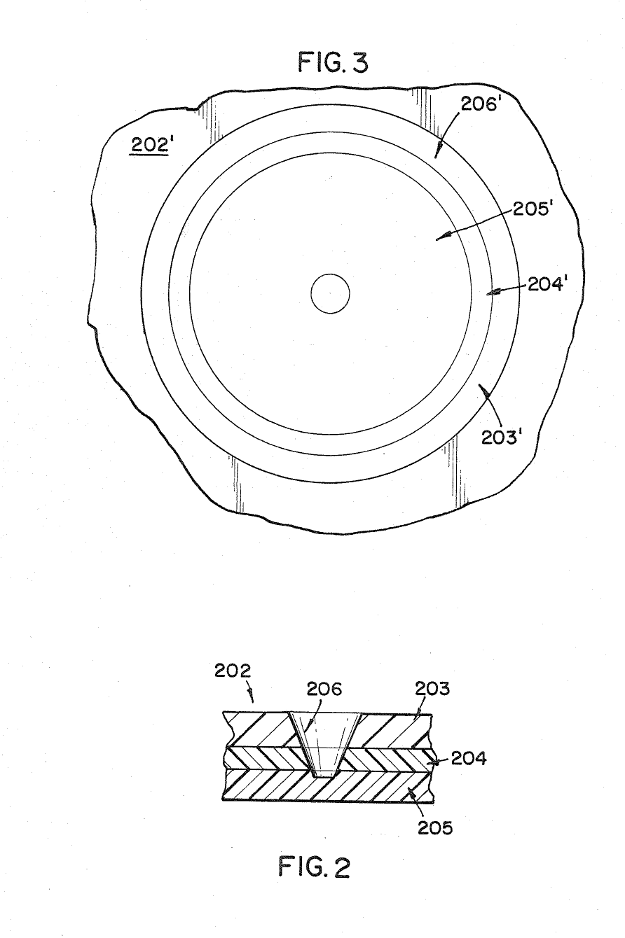

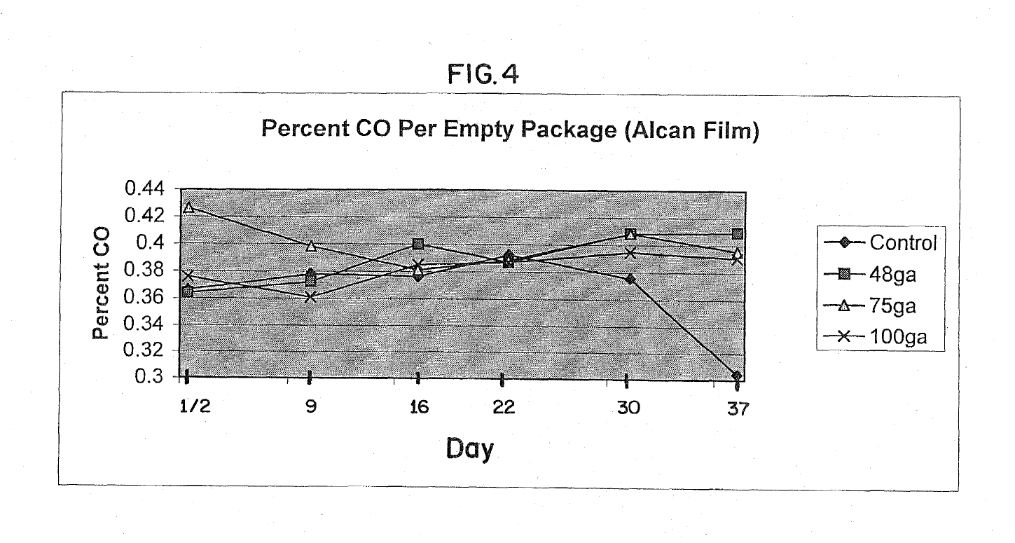

Another possible product package could include a barrier base and a barrier lid with one or both of the base and the lid including micro perforations to allow a controlled rate of oxygen, nitrogen, carbon dioxide, carbon monoxide, and any other ambient air gases into and out of the packaging. The micro perforations extend at least partially to completely through the barrier layer of the packaging component. For example, FIG. 2 shows a schematic cross-section view of a barrier lid 202, which preferably replaces the lid 102 shown in FIG. 1, with a micro perforation 206 extending partially through the barrier lid 202. The barrier lid 202 preferably includes three layers, a structural (nylon) layer 203, a barrier (EVOH) layer 204, and a permeable sealant (polyethylene) layer 205. In FIG. 2, the micro perforation 206 extends through the structural layer 203 and the barrier layer 204 but not the permeable sealant layer 205. FIG. 3 shows a photo of a barrier lid 202′ with a micro perforation 206′ extending partially through the barrier lid 202′. The photo was taken under a microscope. The barrier lid 202′ preferably includes three layers, a structural (nylon) layer 203′, a barrier (EVOH) layer 204′, and a permeable sealant (polyethylene) layer 205′. In FIG. 3, the micro perforation 206′ extends through the structural layer 203′ and the barrier layer 204′ but not the permeable sealant layer 205′. The micro perforations are preferably 10 to 1000 microns in diameter, and there are preferably 1 to 100 micro perforations per product packaging. The micro perforations could be even smaller in size or diameter. It is recognized that the size, diameter, location, and number of micro perforations could depend upon the type of the meat, the cut of meat, and the amount of meat in the packaging and could also depend upon the meat to gas volume ratios in the product packaging.

Another possible product packaging could include a barrier base and a barrier lid with micro perforations in the lid. A peelable label could cover the micro perforations until the product packaging is to be displayed. Peeling the label away from the lid would expose the micro perforations and allow oxygen to begin to diffuse into the product packaging.

To create a preferred product package, the meat product having a first color is placed in a base. The meat product and the base are placed in packaging equipment where the air is evacuated from the base and the base is filled with a gas. The lid is then sealed to the base to assist in containing the gas within the product package.

Over a period of time, the color of the meat products changes through controlled conversion from carboxymyoglobin to varying degrees of metmyoglobin. The product packaging, regardless of its composition, should allow 0.1 to 15 cc of oxygen per package in 24 hours. This is the oxygen transmission rate (“OTR”). It is recognized that the OTR could depend upon the temperature at which the product package is stored, the amount of light to which the product package is exposed, the volume of the meat, the amount of exposed surface area of the meat to the gases, the type of meat, the cut of meat, the age of the meat, the meat to gas ratio (headspace), the surface area of the base and/or the lid, the type of package materials, the age of the package materials, and other factors. Thus, the desired gradual color change of the meat product could depend upon the OTR and the factors that could affect the OTR.

The controlled rate of oxygen diffusing into the product packaging over a predetermined number of days allows the color of the meat to gradually change within the product packaging. The color preferably begins to noticeably change after 18 to 90 days from when the meat product has been packaged in the product packaging. Preferably, the color of the meat product will noticeably change proximate after the end of the meat product's stated shelf-life indicia on the product packaging. Although not all meat products will change color at the same time or with the same intensity, the color will eventually change within the package.

By lowering the gas to meat ratio (headspace) or the level or volume of CO in a barrier lidstock package, it has been found that the meat will eventually deplete the reservoir of CO and start to gradually turn a reddish brown to brown color over time. This change appears to be accelerated when the packages are placed in a refrigerated display case under lights. However, if the headspace is too low, there may not be enough CO to develop a robust red color proximate after packaging. Thus, a certain level of CO is needed to get the color of the meat to fully bloom. It is also recognized that variables such as but not limited to the type of meat, the cut of meat, the amount of headspace, the temperature, the light, the base material, the lid material, and other variables could also affect the shelf-life and the meat color.

To determine preferred MAP conditions including CO and achieve extended shelf-life, various tests were performed.

### Example 1

One test was putting a pin-sized hole approximately 500 microns in diameter completely through a barrier lidstock film proximate a corner of the barrier lidstock film on packaged product and then covering the hole with a peelable label. This was done on packaged products with various sizes and depths. The labels were peeled off the packages upon placement of the packages in a refrigerated display case. It was found that beef cuts in the packages of various sizes and depths turned a very unappealing grey or brownish-grey color within 36 to 48 hours in the display case. The pin-sized hole in each package apparently allowed just enough oxygen into the package to initially create a partial pressure of oxygen within the package with levels of oxygen ranging from approximately 0.1 to 2.0%, which had a very detrimental effect on the meat color.

The effect of low levels of oxygen will vary depending upon the species, the muscles, and in some cases, certain areas within muscles. Generally, beef appears to be more sensitive to low levels of oxygen than pork.

Even if the color had little noticeable change for 2 to 3 days, the retailer would not be able to rely upon the “use by” or “freeze by” indicia placed on the package at the packaging facility and would have to put another “use by” or “freeze by” indicia on each package upon placement in the display case, which is an added step for the retailer. Thus, this option is less desirable.

### Example 2

Another test was putting lasered microscopic holes approximately 300 microns in diameter completely through a barrier lidstock film. The bases were #3 footprint, 2 inches deep (Order Code CS978) manufactured by Crovac. The number of holes in the packages tested varied from none (control) to three. It was thought that by reducing the size of the hole(s), the ingress of oxygen into the MAP package could be controlled to some degree. However, it was found that only one lasered hole was enough to create a partial pressure condition for oxygen in the package sufficient enough to produce unacceptable shades of brown and grey in the meat within 48 hours.

### Example 3

Another test was making “indentations” or partially extending micro perforations in a barrier lidstock film comprising a nylon layer, an EVOH layer, and a permeable polyethylene (“PE”) layer. The bases were #3 footprint, 1.7 inches deep (Order Code CS977) manufactured by Crovac. The nylon layer was approximately 7 microns thick, the EVOH layer was approximately 9 microns thick, and the PE layer was approximately 20 microns thick. The indentations were approximately 200 microns in diameter and approximately 20 to 22 microns deep. The laser completely penetrated just the nylon and EVOH layers but did not completely penetrate the PE layer. The barrier film was processed such that six indentations appeared on each package during indexing on a Multivac 200 lidstock packaging machine. For this test, none to six (control) of the indentations were covered. Although there were some signs of color change after 40 to 50 days, the meat color in all of the treatments remained relatively stable well beyond the code date.

Another test was conducted with 16 indentations, and the results were similar to those obtained for the tests with six indentations. Thus, it is expected that by further increasing the number of indentations or by increasing the diameters of the indentations, more favorable results could be obtained.

### Example 4

Another test was conducted whereby samples of existing lidstock trays in varying sizes and depths were made without the EVOH layer, and barrier lidstock films were used. The trays were as shown in Table 1.

TABLE 1
Tray Descriptions

| | | Industry Standard Footprint Number (#9 |
|---|---|---|
| | Thickness (mil) of | footprints are also called Family pack trays), |
| Cryovac Order | sheet material prior to tray | Size (Length × Width) in inches, Depth in |
| Code | being formed | inches of Tray |
| CS1175 | 32 | #10 11″ × 7″ 1.2″ depth |
| CS12105 | 31 | #9 12″ × 10″ 1.3″ depth, Family pack |
| CS975D | 28 | #3 9 × 7″ 1.4″ depth |
| CS1088 | 33 | #5 10″ × 8″ 2″ depth |
| CS121013 | 41 | #9 12″ × 10″ 3.13″ depth, Family pack |
| CS9715 | 51 | #3 9″ × 7″ 3.7″ depth |
| CS12104 | 28 | #9 12″ × 10″ 1″ depth, Family pack |
| CS978 | 36 | #3 9″ × 7″ 2″ depth |
| CF12108 | 32 | #9 12″ × 10″ 2″ depth, Family pack |

The trays were sent to a case ready producing facility and were packaged with varying cuts of beef. The color life of the meat in the display case was dependent on the cut of beef and the dimensions of the tray. In general, most cuts of beef started to discolor prior to code date. It is expected that different tray sizes and different thicknesses could provide the desired results.

### Example 5

Non-barrier lidstock trays having varying thicknesses with barrier films were tested. It appears that the transmission rate of oxygen into the package can be reasonably controlled by adjusting the thickness of the formed tray. Tests were conducted using #3 footprint, 9 inches long, 7 inches wide, and 2 inches deep, trays manufactured by Cryovac (Order Code CS978) from which the EVOH barrier layer was removed. The trays were manufactured in four different sheet thicknesses: 36, 45, 55, and 65 mil. Initial tests showed that beef cuts generally started to turn a brownish red prior to code date in the 36 mil tray. As the thickness of the tray increased, the color life of the beef cuts progressively increased.

The degree and rate of color change were also dependent on the cut of beef. Strip steaks, top round steaks, and top sirloin steaks, all “Select” or higher quality, were evaluated. Tables 2-4 show how these cuts of beef reacted differently with CO, CO₂, and O₂ in non-barrier trays of varying thicknesses at the end of 53 days. The color symbols in Tables 2-4 are as follows: R is red, PR is pinkish red, DR is dark red, RB is reddish brown, BR is brownish red, B is brown, PB is pinkish brown, BP is brownish pink, DB is dark brown, and G is green.

TABLE 2
Colors of Beef Strip Steaks and Percentages
of CO, CO₂, and O₂ after 53 Days

| SAMPLE | COLOR | % CO | % CO₂ | % O₂ |
|---|---|---|---|---|
| SS1-non-barrier 36 mil (2) | B/BR | 0.142 | 26.06 | 0.035 |
| SS1-non-barrier 45 mil (2) | RB/R | 0.142 | 26.86 | 0.023 |
| SS1-non-barrier 65 mil (2) | R/RB/B | 0.148 | 27.91 | 0.189 |
| SS2-non-barrier 36 mil (2) | B/BR/G | 0.074 | 27.01 | 0.289 |
| SS2-nonbarrier 45 mil (2) | BR/R/G | 0.061 | 26.56 | 0.069 |
| SS2-non-barrier 55 mil (2) | RB/R/B/G | 0.085 | 27.62 | 0.041 |
| SS2-non-barrier 65 mil (2) | R/RB/PB/G | 0.086 | 27.57 | 0.021 |

TABLE 3
Colors of Beef Top Round Steaks and Percentages
of CO, CO₂, and O₂ after 53 Days

| SAMPLE | COLOR | % CO | % CO₂ | % O₂ |
|---|---|---|---|---|
| TR1-non-barrier 36 mil | B/RB/DR | 0.141 | 32.50 | 0.007 |
| TR1-non-barrier 45 mil | B/PB/R | 0.033 | 32.15 | 0.000 |
| TR1-non-barrier 55 mil | R/RB/B | 0.142 | 31.90 | 0.000 |
| TR1-non-barrier 65 mil | RB/B | 0.150 | 31.40 | 0.029 |
| TR2-non-barrier 36 mil | B/BR | 0.079 | 35.72 | 0.161 |
| TR2-non-barrier 45 mil | R/RB/B | 0.089 | 32.66 | 0.071 |
| TR2-non-barrier 55 mil | RB/BR/B | 0.089 | 33.73 | 0.058 |
| TR2-non-barrier 65 mil | R/PR/PB | 0.080 | 40.69 | 0.025 |
| TR3-non-barrier 36 mil | B/BR/DR | 0.095 | 29.94 | 0.012 |
| TR3-non-barrier 45 mil | B/BP/PR | 0.069 | 35.06 | 0.000 |
| TR3-non-barrier 55 mil | RB/B/R | 0.114 | 34.82 | 0.078 |
| TR3-non-barrier 65 mil | R/RB/B | 0.035 | 30.20 | 0.069 |

TABLE 4
Colors of Beef Top Sirloin Steaks and Percentages
of CO, CO₂, and O₂ after 53 Days

| SAMPLE | COLOR | % CO | % CO₂ | % O₂ |
|---|---|---|---|---|
| TS1-non-barrier 36 mil | B/BR | 0.072 | 35.86 | 0.011 |
| TS1-non-barrier 45 mil | B/BR/R | 0.058 | 34.02 | 0.000 |
| TS1-non-barrier 65 mil | B/BR/R | 0.047 | 34.98 | 0.000 |
| TS2-non-barrier 36 mil | DB/B/BR | 0.111 | 33.07 | 0.000 |
| TS2-non-barrier 45 mil | B/BR | 0.089 | 33.35 | 0.000 |
| TS2-non-barrier 55 mil | DB/B/BR | 0.044 | 36.23 | 0.105 |

Generally, Tables 2-4 show, based on visual inspection of color, the strip steaks remained more stable than the top round steaks and the top sirloin steaks. Each cut reacted somewhat differently. There was no homogenous color; there were varying shades of color as noted in the color symbols. The top sirloin steaks appeared to have more shades of brown than the other two cuts. The top sirloin steaks also showed lower residual oxygen levels in the packages, which indicates that the top sirloin steaks reacted more strongly with the oxygen transmitting through the non-barrier trays. There appears to be an interaction between the amount of CO in the package, the amount of myoglobin reductase in the muscle, and the amount of oxygen transmitting into the package over time.

All of the beef cuts in the non-barrier trays changed color to some extent based on the thickness of the trays. A more noticeable change was noted with the 36 mil trays and a less noticeable change was noted with the 65 mil trays. The color of the strip steaks was more stable, less sensitive to oxidation, than the top round steaks followed by the top sirloin steaks. Over time, the strip steaks turned a dull red to a reddish-brown to a brownish-red within 18-50 days depending upon the tray thickness and the amount of time in the display case. Over time, the top round steaks turned a dull/pale red (based on muscle location) to a brownish-red to shades of brown. Over time, color changes were most noticeable in the top sirloin steaks, which showed some signs of browning as early as 18-24 days in the 36 mil trays.

### Example 6

Transmission rate data was obtained for several types of product packaging comprising barrier bases and semi-barrier films by measuring the percentages of carbon monoxide, carbon dioxide, and oxygen in the product packaging over several days.

One type of product packaging was a control comprising a #3 footprint, 9 inches long, 7 inches wide, and 1.7 inches deep, tray manufactured by Cryovac (Order Code CS977) as the base and LID1050 barrier lidstock film manufactured by Cryovac as the lid. A second type of product packaging was a #3 footprint, 9 inches long, 7 inches wide, and 1.7 inches deep, tray manufactured by Cryovac (Order Code CS977) as the base and a 48 gauge (“ga”) semi-barrier film manufactured by Alcan Packaging Food as the lid. A third type of product packaging was a #3 footprint, 9 inches long, 7 inches wide, and 1.7 inches deep, tray manufactured by Cryovac (Order Code CS977) as the base and a 75 ga semi-barrier film manufactured by Alcan Packaging Food as the lid. A fourth type of product packaging was a #3 footprint, 9 inches long, 7 inches wide, and 1.7 inches deep, tray manufactured by Cryovac (Order Code CS977) as the base and a 100 ga semi-barrier film manufactured by Alcan Packaging Food as the lid. The semi-barrier films used in the second, third, and fourth types of product packaging were polyester film with a polyethylene sealant layer.

The control and the 48 ga packages were packaged on day 1, and the 75 ga and 100 ga packages were packaged on day 2. During packaging of the product packaging, the vacuum level was set at 10 millibars (“mb”) on a T200 compact Multivac Traysealer manufactured by Multivac, Sepp Haggenmüller GmbH & Co. KG and the gas tank was set at 0.4% carbon monoxide, 35% carbon dioxide, and the remaining percent nitrogen. After packaging, each product packaging included carbon monoxide (“CO”), carbon dioxide (“CO₂”), and oxygen (“O₂”) in the percentages shown in Table 2. All of the packages were empty (did not contain any meat products) and were stored in a dark cooler at approximately 34 to 36° F.

A Bridge MAP (Modified Atmosphere Packaging) Tri-Gas Case-Ready Meat Headspace Gas Analyzer, Model 900121, manufactured by Bridge Analyzers, Inc. was used to measure the transmission rates of each product packaging by measuring the percentages of CO, CO₂, and O₂. The transmission rates were measured with an error rate of +/−5%. The percentages of CO, CO₂, and O₂ were measured on the day of packaging (days 1 and 2) and then on days 9, 16, 22, 30, 37, and 46. Several packages of each type of product packaging were measured, and the averages of the results for each type of product packaging are shown in Tables 5-11.

TABLE 5
Average Percentages of CO, CO₂, and O₂ in
Packaging with Semi-Barrier Film
Days 1 and 2

| | Average | Average | Average |
|---|---|---|---|
| Packaging | % CO | % CO₂ | % O₂ |
| Control | 0.366 | 33.553 | 0.061 |
| 48 ga | 0.364 | 34.020 | 0.063 |
| 75 ga | 0.427 | 35.195 | 0.026 |
| 100 ga | 0.376 | 29.887 | 0.050 |

TABLE 6
Average Percentages of CO, CO₂, and O₂ in
Packaging with Semi-Barrier Film
Day 9

| | Average | Average | Average |
|---|---|---|---|
| Packaging | % CO | % CO₂ | % O₂ |
| Control | 0.378 | 32.334 | 0.028 |
| 48 ga | 0.372 | 30.599 | 0.184 |
| 75 ga | 0.398 | 34.608 | 0.115 |
| 100 ga | 0.361 | 33.118 | 0.099 |

TABLE 7
Average Percentages of CO, CO₂, and O₂ in
Packaging with Semi-Barrier Film
Day 16

| | Average | Average | Average |
|---|---|---|---|
| Packaging | % CO | % CO₂ | % O₂ |
| Control | 0.377 | 30.189 | 0.048 |
| 48 ga | 0.400 | 30.319 | 0.353 |
| 75 ga | 0.381 | 28.921 | 0.211 |
| 100 ga | 0.385 | 29.904 | 0.166 |

TABLE 8
Average Percentages of CO, CO₂, and O₂ in
Packaging with Semi-Barrier Film
Day 22

| | Average | Average | Average |
|---|---|---|---|
| Packaging | % CO | % CO₂ | % O₂ |
| Control | 0.393 | 31.120 | 0.096 |
| 48 ga | 0.387 | 30.138 | 0.482 |
| 75 ga | 0.388 | 31.050 | 0.324 |
| 100 ga | 0.387 | 29.524 | 0.238 |

TABLE 9
Average Percentages of CO, CO₂, and O₂ in
Packaging with Semi-Barrier Film
Day 30

| | Average | Average | Average |
|---|---|---|---|
| Packaging | % CO | % CO₂ | % O₂ |
| Control | 0.376 | 32.024 | 0.124 |
| 48 ga | 0.409 | 26.398 | 0.682 |
| 75 ga | 0.408 | 27.886 | 0.456 |
| 100 ga | 0.395 | 28.362 | 0.328 |

TABLE 10
Average Percentages of CO, CO₂, and O₂ in
Packaging with Semi-Barrier Film
Day 37

| | Average | Average | Average |
|---|---|---|---|
| Packaging | % CO | % CO₂ | % O₂ |
| Control | 0.304 | 30.418 | 0.138 |
| 48 ga | 0.409 | 25.526 | 0.810 |
| 75 ga | 0.396 | 27.306 | 0.548 |
| 100 ga | 0.391 | 28.288 | 0.410 |

TABLE 11
Average Percentages of CO, CO₂, and O₂ in
Packaging with Semi-Barrier Film
Day 46

| | Average | Average | Average |
|---|---|---|---|
| Packaging | % CO | % CO₂ | % O₂ |
| Control | 0.378 | 32.684 | 0.139 |
| 48 ga | 0.382 | 25.060 | 1.069 |
| 75 ga | 0.427 | 28.112 | 0.629 |
| 100 ga | 0.405 | 29.174 | 0.511 |

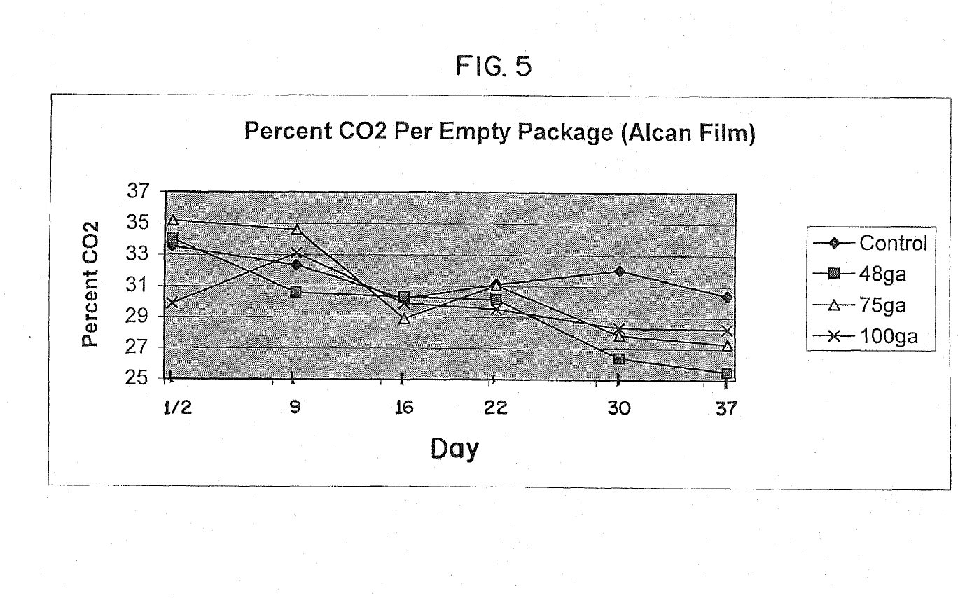

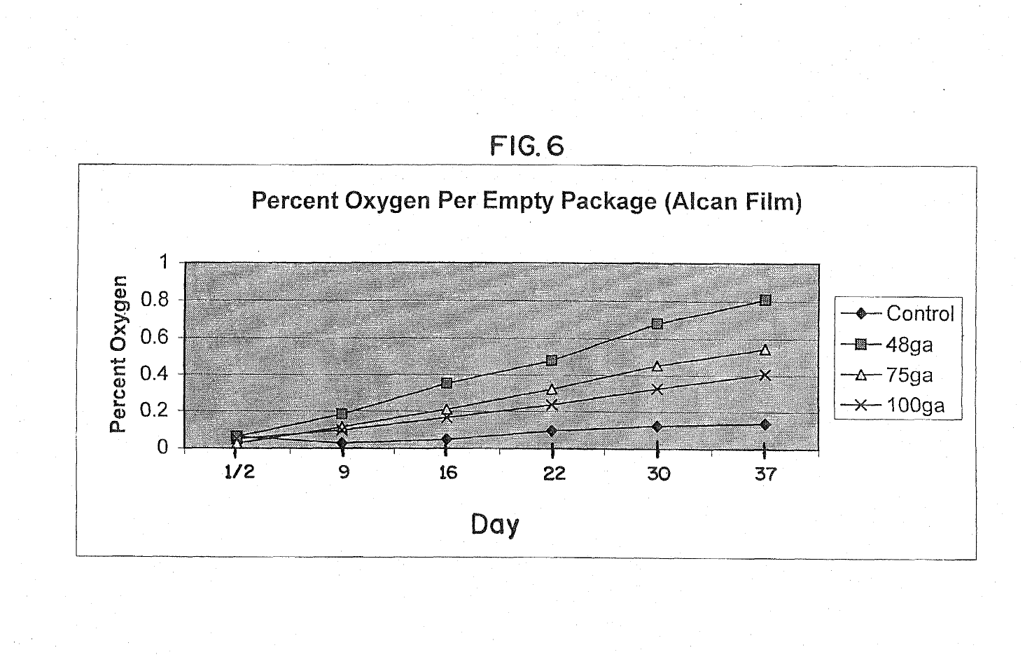

As shown in Tables 5-11 and FIGS. 4-6, these results show as the thicknesses of the films increased, the oxygen transmission rates decreased. These results also show that for packages without meat products the levels of carbon monoxide stayed relatively constant and the levels of carbon dioxide decreased at a very slow rate within the packages. Thus, the MAP gases within the packages stayed relatively stable. It is recognized that for packages containing meat products the gas levels could change due to interactions between the gases and the meat products.

Test results to date have been mixed. Either the film has been too permeable and the meat color has become an unacceptable color within 7 to 14 days or the film has not been permeable enough and the meat color stays fairly red for an extended period of time after the code date on the package. It is expected that a sufficiently engineered semi-permeable film could achieve the desired results.

### Example 7

Transmission rate data was obtained for several types of product packaging comprising non-barrier bases and barrier films by measuring the percentages of carbon monoxide, carbon dioxide, and oxygen in the product packaging over several days. The bases were #3 footprint, 9 inches long, 7 inches wide, and 2 inches deep, manufactured by Cryovac having sheet thicknesses of 36, 45, 55, and 65 mil. The barrier films were LID1050 barrier lidstock film manufactured by Cryovac. The control base was #3 footprint, 2 inches deep with an EVOH layer and a total thickness of 36 mil manufactured by Cryovac and lid was LID1050 barrier lidstock film manufactured by Cryovac.

During packaging of the product packaging, the vacuum level was set at 10 millibars (“mb”) on a T200 compact Multivac Traysealer manufactured by Multivac, Sepp Haggenmüller GmbH & Co. KG and the gas tank was set at 0.4% carbon monoxide, 35% carbon dioxide, and the remaining percent nitrogen. After packaging, each product packaging included carbon monoxide (“CO”), carbon dioxide (“CO₂”), and oxygen (“O₂”) in the percentages shown in Tables 12 and 13. All of the packages were empty (did not contain any meat products) and were stored in a dark cooler at approximately 34 to 36° F.

A Bridge MAP (Modified Atmosphere Packaging) Tri-Gas Case-Ready Meat Headspace Gas Analyzer, Model 900121, manufactured by Bridge Analyzers, Inc. was used to measure the transmission rates of each product packaging by measuring the percentages of CO, CO₂, and O₂. The transmission rates were measured with an error rate of +/−5%. The percentages of CO, CO₂, and O₂ were measured on the day of packaging (day 1) and then on the days shown in Tables 12 and 13. Several packages of each type of product packaging were measured, and the averages of the results for each type of product packaging are shown in Tables 12 and 13.

TABLE 12
Average Percentages of CO, CO₂, and O₂ in Packaging with Semi-Barrier Bases

| | 36 mil | | | 45 mil | | | 55 mil | | | 65 mil | | |
|---|---|---|---|---|---|---|---|---|---|---|---|---|
| Day | CO | CO2 | O2 | CO | CO2 | O2 | CO | CO2 | O2 | CO | CO2 | O2 |
| 1 | 0.393 | 32.95 | 0.048 | — | — | — | — | — | — | — | — | — |
| 8 | 0.363 | 31.78 | 0.34 | 0.397 | 30.32 | 0.26 | 0.395 | 30.25 | 0.26 | 0.389 | 29.77 | 0.23 |
| 15 | 0.395 | 29.13 | 0.67 | 0.389 | 29.06 | 0.53 | 0.375 | 28.77 | 0.48 | 0.386 | 27.9 | 0.4 |
| 23 | 0.391 | 29.43 | 0.856 | 0.395 | 30.07 | 0.75 | 0.393 | 30.18 | 0.696 | 0.39 | 30.53 | 0.568 |
| 33 | 0.401 | 29.14 | 1.195 | 0.396 | 29.82 | 1.059 | 0.384 | 29.14 | 0.93 | 0.395 | 30.43 | 0.849 |
| 36 | 0.421 | 28.96 | 1.319 | 0.42 | 29.06 | 1.195 | 0.39 | 28.96 | 1.08 | 0.392 | 28.98 | 0.91 |
| 48 | 0.369 | 25.12 | 1.818 | 0.397 | 27.17 | 1.573 | — | — | — | 0.388 | 28.61 | 1.349 |
| 50 | — | — | — | 0.415 | 27.28 | 1.689 | — | — | — | — | — | — |

TABLE 13
Average Percentages of CO, CO₂, and O₂ in Packaging with Semi-Barrier Bases

| | Control | | | 36 mil | | | 45 mil | | |
|---|---|---|---|---|---|---|---|---|---|
| Day | CO | CO2 | O2 | CO | CO2 | O2 | CO | CO2 | O2 |
| 1 | 0.381 | 34.8 | 0.1 | | | | | | |
| 5 | 0.398 | 30.84 | 0.1185 | 0.4 | 30.38333 | 0.194667 | 0.400667 | 30.5 | 0.1497 |
| 7 | 0.390 | 32.1 | 0.1115 | 0.399 | 31.02 | 0.2475 | 0.399 | 30.885 | 0.188 |
| 9 | 0.395 | 33.24 | 0.116 | 0.403 | 31.93 | 0.346 | 0.4055 | 32.235 | 0.2545 |
| 15 | 0.383 | 31.99 | 0.103 | 0.383 | 29.815 | 0.6145 | 0.3865 | 29.95 | 0.392 |

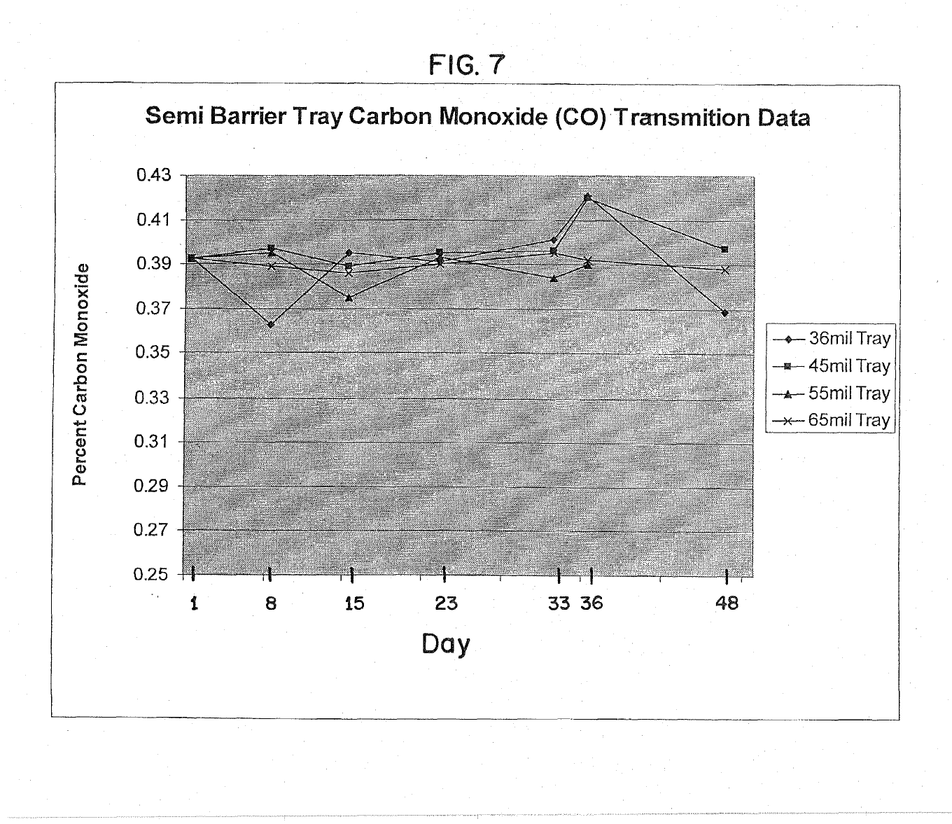

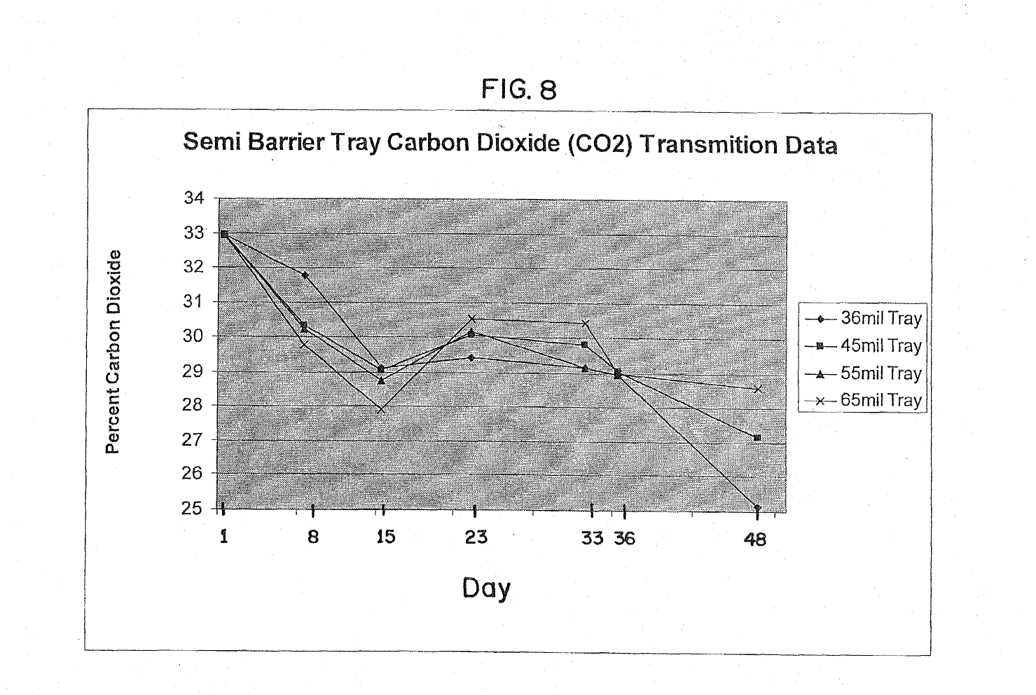

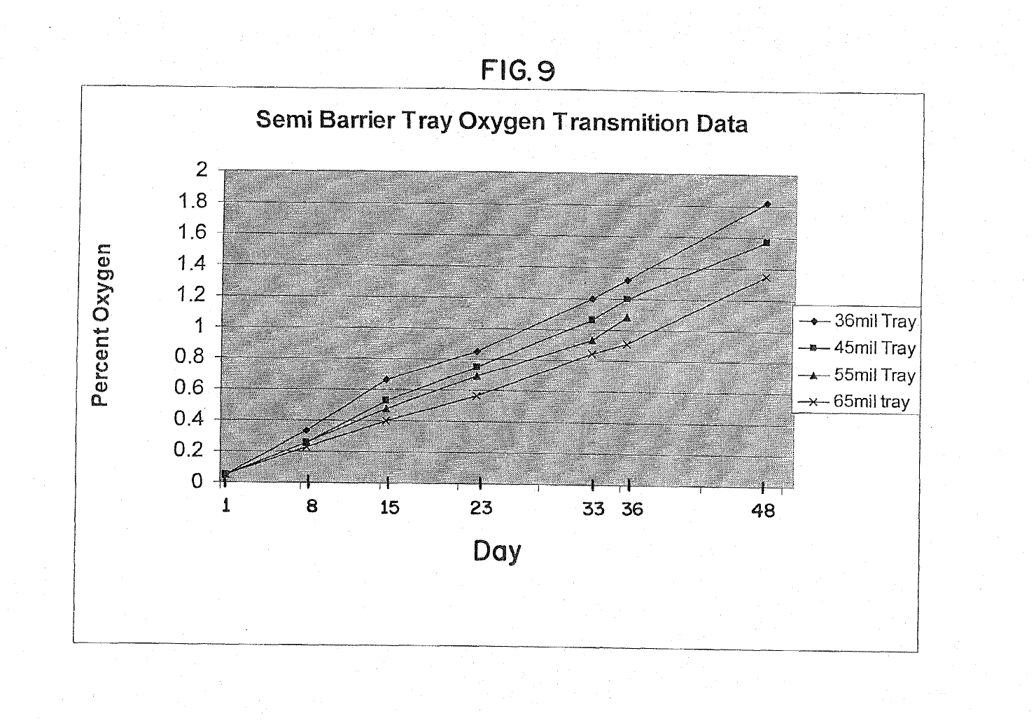

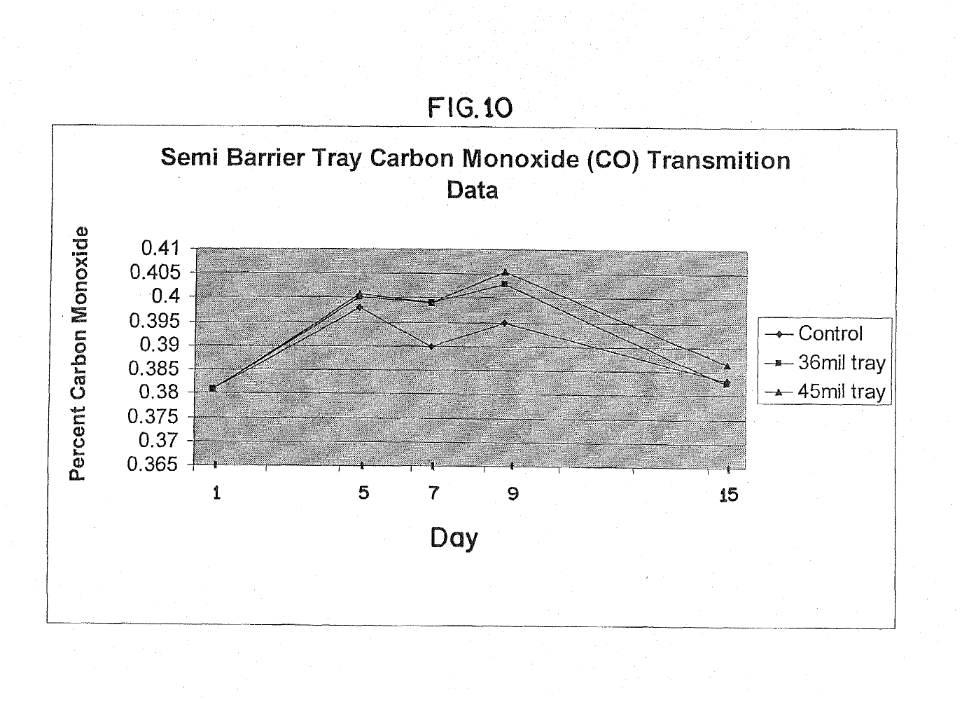

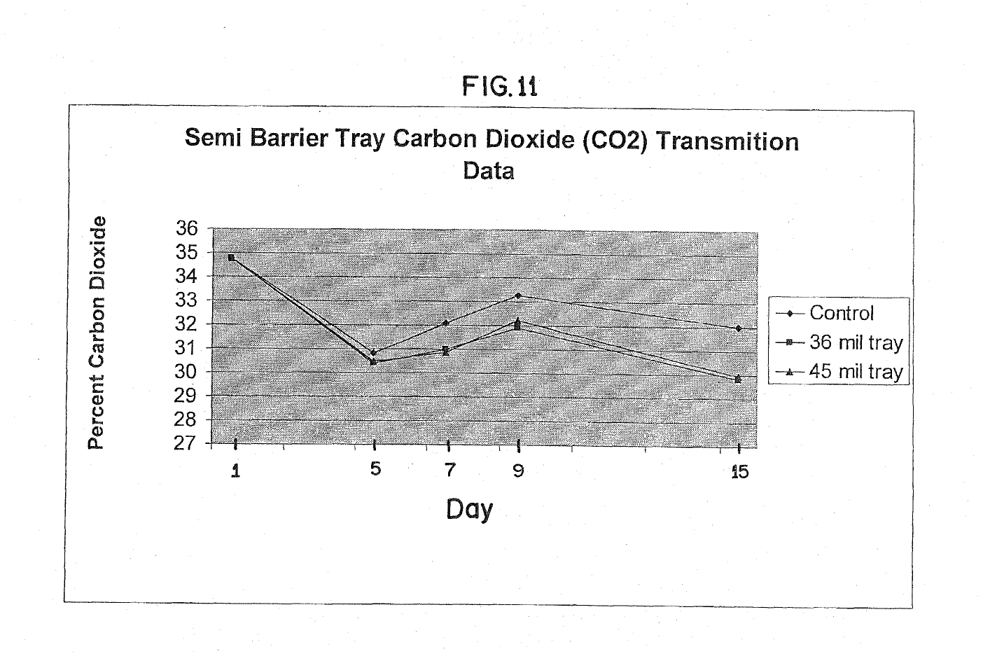

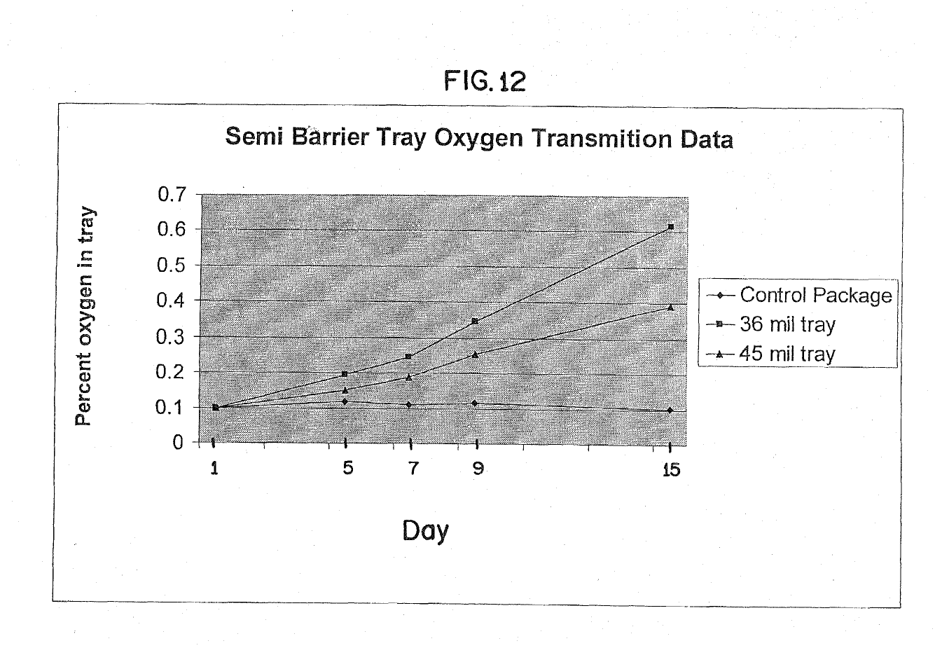

Table 12 and corresponding FIGS. 7-9 and Table 13 and corresponding FIGS. 10-12 show as the thicknesses of the bases or trays increased, the oxygen transmission rates decreased. These results also show that for packages without meat products the levels of carbon monoxide stayed relatively constant and the levels of carbon dioxide decreased at a very slow rate within the packages. Thus, the MAP gases within the packages stayed relatively stable. It is recognized that for packages containing meat products the gas levels could change due to interactions between the gases and the meat products.

The oxygen transmission rates for these packages were as shown in Table 14.

TABLE 14
Oxygen Transmission Rates for Packages with Semi-Barrier Bases

| | | OTR | Approximate |
|---|---|---|---|
| | | (cc of oxygen per package in | Temperature |
| Data Source | Package | 24 hours +/− 0.1) | (° F.) |
| Cryovac | Control | 0.256 | 72 |
| | 36 mil | 1.820 | 72 |
| | 45 mil | 1.580 | 72 |
| | 55 mil | 1.320 | 72 |
| | 65 mil | 1.120 | 72 |
| Actual Data from | Control | 0.004 to 0.090 | 34 to 36 |
| Test in Example 7 | | | |
| | 36 mil | 0.450 to 0.850 | 34 to 36 |
| | 45 mil | 0.230 to 0.650 | 34 to 36 |
| | 55 mil | 0.520 to 0.580 | 34 to 36 |
| | 65 mil | 0.440 to 0.500 | 34 to 36 |

The data provided by Cryovac was not determined during the testing in Example 7 but was provided independently. The actual data from the testing in Example 7 was determined during the testing. This data shows the affect the temperature has on the OTR.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A product packaging, comprising:
a base and a lid forming a cavity having a first volume;
a meat product having a first color and a second volume, the second volume being smaller than the first volume, the cavity configured and arranged to receive the meat product;
a space between the base, the lid, and the meat product having a third volume, the third volume being the difference between the first volume and the second volume;
a gas within the space, the gas comprising no greater than 30% carbon monoxide; and
wherein at least one of the base and the lid has an oxygen transmission rate of 0.1 to 15 cc of oxygen per package in 24 hours so that in 18 to 90 days the first color of the meat product has noticeably changed to a second color.

2. The product packaging of claim 1, wherein the gas further comprises 0 to 80% nitrogen and 20 to less than 100% carbon dioxide.

3. The product packaging of claim 2, wherein the gas comprises 1.20% or less carbon monoxide.

4. The product packaging of claim 1, further comprising a shelf-life indicia on at least one of the base and the lid, wherein the meat product has noticeably changed to the second color proximate after expiration of the shelf-life indicia.

5. The product packaging of claim 1, wherein the base is formed of a material selected from the group consisting of molded polyester, polystyrene, high density polyethylene, polyvinylchloride, and polypropylene and is approximately 10 to 100 mil thick.

6. The product packaging of claim 1, wherein a gas to meat product volume ratio is no greater than 0.8 to 1.

7. The product packaging of claim 1, wherein the base is made of a barrier material and the lid is made of a non-barrier material.

8. The product packaging of claim 1, wherein the base is made of a non-barrier material and the lid is made of a barrier material.

9. The product packaging of claim 1, wherein the base is made of a non-barrier material and the lid is made of a non-barrier material.

10. The product packaging of claim 1, wherein the base is made of a first barrier material and the lid is made of a second barrier material and at least one of the base and the lid include a plurality of micro perforations extending at least partially to completely through a barrier layer of the barrier material.

11. The product packaging of claim 10, wherein the second barrier material includes a first layer and a second layer, the micro perforations extending through the first layer, the second layer being at least semi-permeable.

12. The product packaging of claim 10, wherein the second barrier material includes a structural layer, a barrier layer, and a permeable layer, the micro perforations extending through the structural layer and the barrier layer.

13. The product packaging of claim 10, further comprising at least one peelable label covering the plurality of micro perforations, the peelable label being peeled away to expose the micro perforations prior to displaying the product packaging.

14. The product packaging of claim 10, wherein the meat product is selected from the group consisting of beef, pork, and poultry.

15. The product packaging of claim 10, wherein the micro perforations are 10 to 1000 microns in diameter and there are 1 to 100 micro perforations.

16. A modified atmosphere packaging configured and arranged to contain a meat product, comprising:
a base and a lid forming a cavity;
a space between the base and the lid;
a gas within the space, the gas comprising no greater than 1.20% carbon monoxide, 20 to less than 100% carbon monoxide, and 0 to 80% nitrogen; and
wherein at least one of the base and the lid has an oxygen transmission rate of 0.1 to 15 cc of oxygen per package in 24 hours, and wherein the carbon monoxide within the space remains relatively constant and the carbon dioxide within the space decreases at a slow rate.

17. The modified atmosphere packaging of claim 16, further comprising a meat product having a first color, the cavity configured and arranged to receive the meat product, wherein the first color noticeably changes to a second color in 18 to 90 days.

18. The modified atmosphere packaging of claim 17, wherein the meat product changes a composition of the gas within the space.

19. A method of packaging a meat product to create a product package, comprising:
placing the meat product in a base, the meat product having a first color;
placing the meat product and the base in packaging equipment;
evacuating air from the base;
filling the base with a gas;
sealing the lid to the base; and
wherein at least one of the base and the lid has an oxygen transmission rate of 0.1 to 15 cc of oxygen per package in 24 hours so that in 18 to 90 days the first color of the meat product has noticeably changed to a second color.

20. The method of claim 19, further comprising placing indentations in the lid.

21. The method of claim 20, wherein the indentations are placed in the lid prior to sealing the lid to the base.
